(19) United States
(12) Patent Application Publication
(10) Pub. No.: US 2021/0053629 A1
(43) Pub. Date: Feb. 25, 2021

(54) AERODYNAMIC DOOR ASSEMBLY

(71) Applicant: EkoStinger, Inc., East Rochester, NY (US)

(72) Inventor: J. Parr Wiegel, Pittsford, NY (US)

(21) Appl. No.: 16/964,789

(22) PCT Filed: Jan. 24, 2019
(86) PCT No.: PCT/US2019/014950

§ 371 Date: Jul. 24, 2020

Related U.S. Application Data
(60) Provisional application No. 62/621,254, filed on Jan. 24, 2018.

(51) Int. Cl. B62D 35/00

(52) U.S. Cl. CPC B62D 35/001; B62D 35/007

(57) ABSTRACT

An aerodynamic door assembly for a semitrailer having a rear portion is provided. The aerodynamic door assembly comprises a first set of articulated panels having a convergent middle panel and at least one of a top panel and a bottom panel, the first set moveable between an open, deployed configuration and a closed, retracted configuration; and a second set of articulated panels having a convergent middle panel and at least one of a top panel and a bottom panel, the second set moveable between an open, deployed configuration and a retracted configuration, wherein in the deployed configuration an outer edge of the convergent middle panel of the first set of articulated panels is proximate an outer edge of the convergent middle panel of the second set of articulated panels and spaced from the rear portion of the semitrailer.

### BACKGROUND OF THE INVENTION

### Field of the Invention

The present disclosure relates generally to systems for reducing a drag force and more specifically, a fairing system for reducing drag on a vehicle, and even more specifically, an aerodynamic door assembly for reducing drag on a semitrailer.

### Description of Related Art

There are many areas on a semitrailer that are subject to aerodynamic drag. Reducing drag on the semitrailer results in a reduction in fuel consumption, thereby significantly abating fuel costs, pollution, and conserving natural resources. Additionally, reducing fuel consumption may also directly impact transportation costs of goods, serving businesses and consumers alike.

One area of a trailer where drag forces are high is at the rear of a trailer. Thus, it is desirable to reduce drag at the rear of the semitrailer.

What is needed then is a drag reduction system for a semitrailer that improves fuel economy.

### BRIEF SUMMARY OF THE INVENTION

The present disclosure provides an aerodynamic door assembly for a semitrailer.

In one configuration, an aerodynamic door assembly for a semitrailer having a rear portion is provided and comprises a first set of articulated panels having a convergent middle panel and at least one of a top panel and a bottom panel, the first set moveable between an open, deployed configuration and a closed, retracted configuration, and a second set of articulated panels having a convergent middle panel and at least one of a top panel and a bottom panel, the second set moveable between an open, deployed configuration and a retracted configuration, wherein in the deployed configuration an outer edge of the convergent middle panel of the first set of articulated panels is proximate an outer edge of the convergent middle panel of the second set of articulated panels and spaced from the rear portion of the semitrailer.

In another configuration, a method of deploying an aerodynamic door assembly on a semitrailer having a rear portion is provided. The method comprises pivoting at least one of a top and bottom panel along a side edge of a convergent middle panel of a first set of articulated panels; securing the at least one of the top and bottom panel of the first set of articulated panels in an open position; pivoting at least one of a top and bottom panel along a side edge of a convergent middle panel of a second set of articulated panels; securing the at least one of the top and bottom panel of the second set of articulate panels in an open position; and aligning an outer edge of the convergent middle panel of the first set of articulated panels adjacent with an outer edge of the convergent middle panel of the second set of articulated panels.

In a configuration, the method further includes positioning a first side edge of the at least one of the top and bottom panels of the first set of articulated panels adjacent an edge of the rear portion of the semitrailer; and positioning a first side edge of the least one of the top and bottom panel of the second set of articulated panels adjacent an edge of the rear portion of the semitrailer.

The method, in another configuration includes positioning a second side edge of the top panel of the first set of articulated panels adjacent a second side edge of the top panel of the second set of articulated panels; and positioning a second side edge of the bottom panel of the first set of articulated panels adjacent a second side edge of the bottom panel of the second set of articulated panels. The method may also include locking the first and second sets of articulated panels into a deployed configuration.

### BRIEF DESCRIPTION OF THE SEVERAL VIEWS OF THE DRAWING(S)

The foregoing features of this invention, as well as the invention itself, may be more fully understood from the following description of the drawings in which:

FIG. 1 is a perspective view of an exemplary semitrailer having a rear aerodynamic door assembly installed on a rear of the semitrailer.

FIG. 2 is rear view of the exemplary semitrailer having the rear aerodynamic door assembly installed on rear of the semitrailer.

FIG. 3 is a left side view of the exemplary semitrailer showing a side panel of the rear aerodynamic door assembly.

FIG. 4A is a top view of the exemplary semitrailer showing top panels of the rear aerodynamic door assembly.

FIG. 4B is a bottom view of the exemplary semitrailer showing bottom panels of the rear aerodynamic door assembly.

FIG. 5 is a perspective view of the exemplary semitrailer showing an alternative configuration of the rear aerodynamic door assembly.

FIG. 6 is a left side view of the left side panel, left top panel, and left bottom panel of the rear aerodynamic door assembly.

FIG. 7 is a perspective view of the inside face a left side panel.

FIG. 8 is a bottom view of a top panel of the rear aerodynamic door assembly.

FIG. 9 is a side view of the left panel side of the rear aerodynamic door assembly with the top and bottom panels in an unengaged configuration.

FIG. 10 is a side view of the right panel side of the aerodynamic door assembly in an engaged configuration showing suitable hinge springs.

FIG. 11 is a close-up side view of the right panel side of the aerodynamic door assembly in an engaged configuration, showing suitable hinge springs.

FIG. 12 is a side view of the left panel side of the rear aerodynamic door assembly showing a suitable cable system.

FIG. 13 is a side view of the left panel side of the rear aerodynamic door assembly showing a suitable cam system.

FIG. 14 is a right perspective view of the exemplary semitrailer showing the rear aerodynamic door assembly being installed on rear of the semitrailer.

FIG. 15 is a left perspective view of the exemplary semitrailer showing the rear aerodynamic door assembly being installed on rear of the semitrailer.

FIG. 16 is a rear perspective view of the exemplary semitrailer showing the rear aerodynamic door assembly transitioning from an engaged position to an unengaged position.

FIG. 17 is a rear perspective view of the exemplary semitrailer showing the rear aerodynamic door assembly transitioning from an engaged position to an unengaged position.

FIG. 18 is a rear perspective view of the exemplary semitrailer showing the rear aerodynamic door assembly in an unengaged position.

FIG. 19 is a side view of a frame of a right-side set of articulated panels showing the guide track of the deployment and retraction system of the aerodynamic door assembly.

FIG. 20 is a side view of the frame of the right-side set of articulated panels showing the upper and lower panels of the aerodynamic door assembly in the retracted position.

FIG. 21 is a perspective view of the sled of the deployment and retraction system of the aerodynamic door assembly.

FIG. 22 is a perspective view of the deployment and retraction system of the aerodynamic door assembly showing one configuration of a crank system.

### DETAILED DESCRIPTION OF THE INVENTION

At the outset, it should be appreciated that like drawing numbers on different drawing views identify identical structural elements of the invention. While the present disclosure provides what is presently considered to be the preferred configuration, it is understood that the invention is not limited to the disclosed configuration.

Furthermore, it is understood that the invention is not limited to the particular methodology, materials, and modifications described and as such may vary. It is also understood that the terminology used herein is for the purpose of describing particular elements only, and is not intended to limit the scope of the present invention, which is limited only by the appended claims.

An aerodynamic door assembly for reducing a draft force on a vehicle, and more specifically, on a semitrailer is disclosed. Reducing draft force on a vehicle can decrease fuel costs, pollution, and conserve natural resources. Drag force results from wall shear stress and pressure forces and is determined by the equation:

F_{d}=C_{d}21ρV² A

Wherein C_{d} is the drag coefficient, ρ is the density of air, V is the velocity, and A is the cross-sectional area. One of the areas on a semitrailer subject to significant drag force is the rear of the semitrailer. Thus, the disclosed aerodynamic door assembly provides an aerodynamic shape at the rear of the semitrailer. Although the term “semitrailer” is used throughout the application, it should be appreciated that other vehicle types may be used, including but not limited to, a box truck, van, armored cars, and buses.

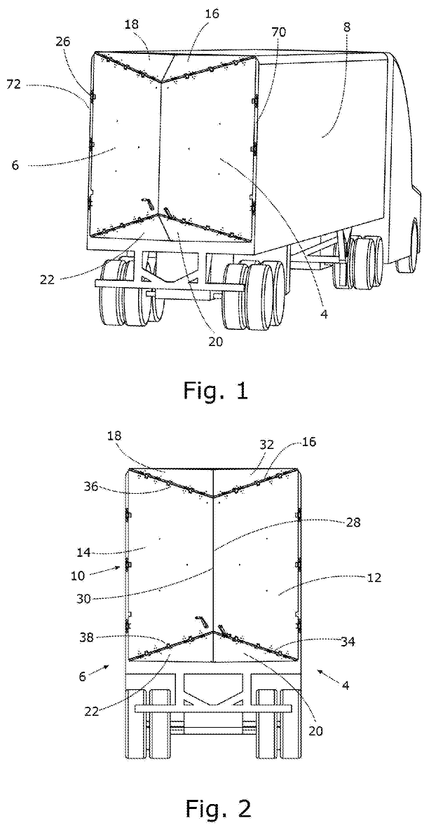

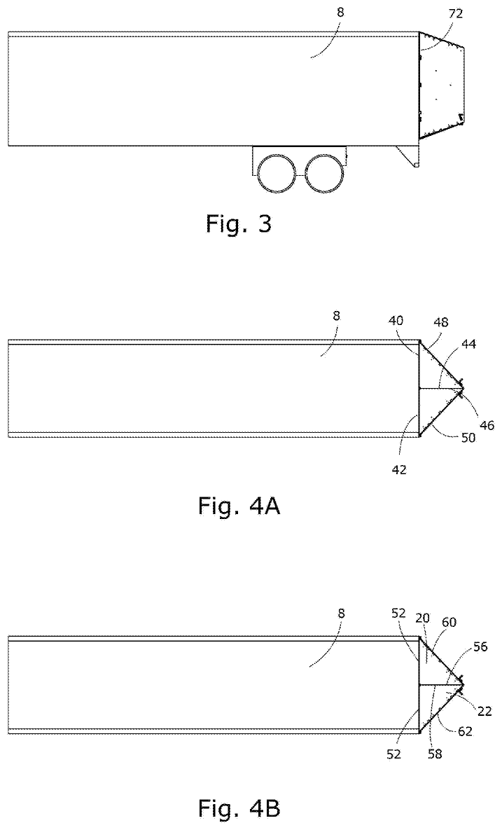

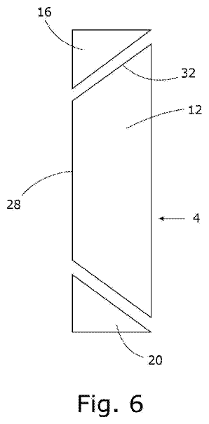

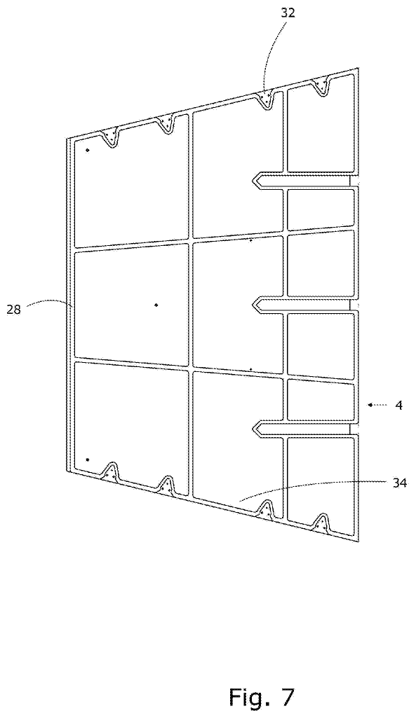

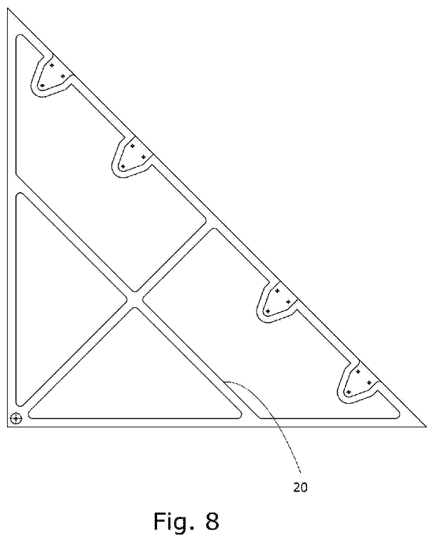

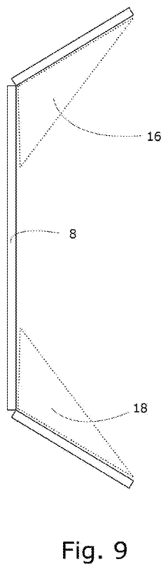

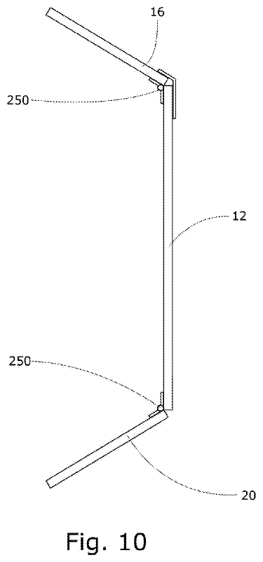

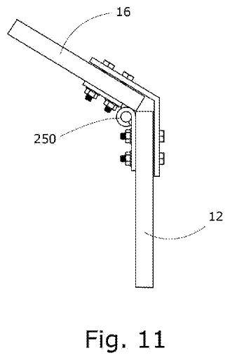

Referring to FIGS. 1-4B and 6-9, aerodynamic door assembly 10 for a rear portion of a semitrailer 8 is disclosed. In one configuration, the aerodynamic door assembly 10 includes two sets of articulated panels 4, 6, wherein each set of articulated panels forms a door of the semitrailer 8. In an alternative configuration, the two sets of articulated panels 4, 6 are in addition to the existing doors of a semitrailer. In either configuration, the first set of articulated panels 4 includes a middle panel 12, a top panel 16, and a bottom panel 20. Similarly, the second set of articulated panels 6 includes a middle panel 14, a top panel 18, and a bottom panel 22. The middle panels 12, 14 include an edge 24, 26 that is pivotally connected to an edge of the rear portion of the semitrailer for rotating the articulated panels 4, 6 about an axis to move the aerodynamic door assembly 8 in an open, deployed configuration or a retracted configuration. The middle panels 12, 14 further include an outer edge 28, 30. In a deployed configuration, the outer edges 28, 30 are proximate to each other and spaced from the rear portion of the semitrailer. The outer edges 28, 30 may be spaced at a predetermined distance at a range of approximately two feet to ten feet. However, other spaced distances are possible and these are intended to be within the scope of the invention as claimed. In one configuration, the spaced distance between the outer edges 28, 30 and the rear portion of the semitrailer in the deployed configuration is four feet. The middle panels are generally converging. By “converging” it is meant that the edges 32 and 34 of panel 12 and edges 36 and 38 of panel 16 are inclined toward each other such that the middle panels 12, 14 are generally trapezoidal. Together, the two sets of panels in the deployed position can reduce aerodynamic drag and increase fuel efficiency.

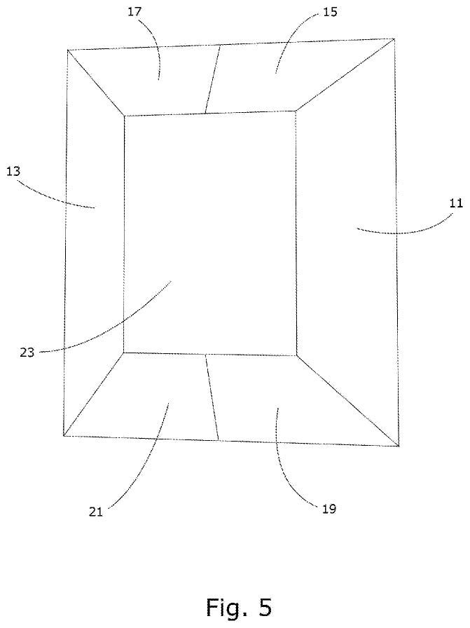

It is contemplated, however, that the middle panels 12, 14 may comprise additional sections to create a fairing that is a different shape and/or angle. For example, the middle panel 12, 14 may each comprise two sections or more sections. In a configuration, as shown in FIG. 5, the aerodynamic door assembly 10 is frustoconical, having two side panels 11, 13, two top panels 15, 17, two bottom panels 19, 21, and a center panel 23. The center panel 23 may be connected to one of the two side panels 11, 13. In one configuration, the center panel 23 is connected with hinges to one of the side panels 11, 13 such that the panel folds against the outside of the panel 11, 13. It should be appreciated by those having ordinary skill that other configurations are possible.

The top and bottom panels 16, 18, 20, 22 are generally triangularly shaped. Top panel 16 includes edges 40, 44 and 48 and top panel 18 includes edges 42, 46, and 50. In a configuration, the edges 48, 50 pivotally rotate along edge 32 of panel 12 and edge 36 of panel 16, respectively. Similarly, bottom panel 20 includes edges 52, 56 and 60 and bottom panel 22 includes edges 54, 58 and 62. In a configuration, edges 60 and 62 pivotally rotate along edge 34 of panel 12 and 38 of panel 16, respectively. It should be appreciated by those having ordinary skill in the art, however, that some configurations may not include bottom panels 20, 22. It should also be understood that the top panels and/or bottom panels may instead be a contiguous panel on the top and a contiguous panel on the bottom. In a deployed configuration, top panels 16, 18 have side edges 40, 42, respectively, that will abut or be adjacent to the top rear portion of the semitrailer. In one configuration, there is no space between the top rear portion of the semitrailer and the side edges 40, 42. Similarly, bottom panels 20, 22 have side edges 52, 54, respectively, that will abut or be adjacent to the bottom rear portion of the semitrailer. Edges 44, 46 of the top panels 16, 18 will be proximate to each other, respectively, in the deployed position and edges 56, 58 of the bottom panels 20, 22 will be proximate to each other, respectively, in the deployed position. The panels 12, 14 are pivotally connected to the rear of the semitrailer 8 along edges 70, 72, respectively. In one configuration, the panels 12, 14 are pivotally connected to the semitrailer 8 via hinges. Exemplary hinges that may be used are the strap hinges, commercially available from Marlboro Manufacturing, Inc., which is available at ttp://www.marlborohinge.com. The articulated panels 4, 6 may rotate along an axis such that the articulated panels 4, 6 overlie left and right sides of the semitrailer. Thus, the panels 4, 6 will not interfere with the loading and unloading of cargo. The top and bottom panels 16, 18, 20, 22, in one configuration are releaseably secured to the edge of the semitrailer. For example, side edges 40, 42 of top panel and 52, 54 of bottom panel may be releasably secured to the adjacent edge of the semitrailer by releasable locks and/or latches.

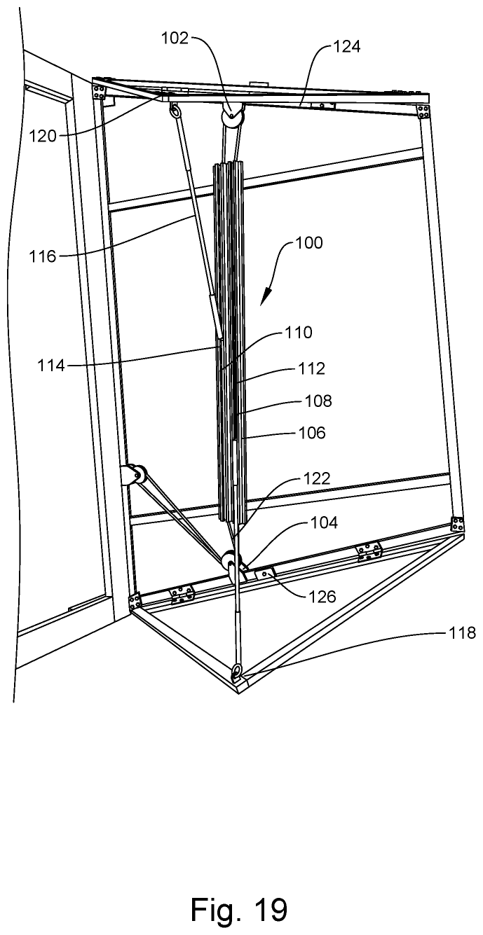

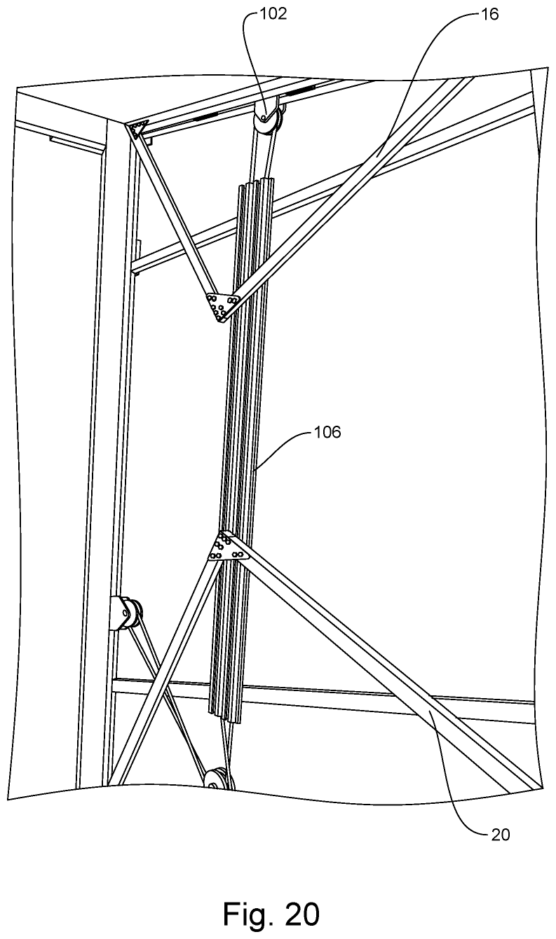

It should be appreciated that the panels may be constructed in various configurations. As shown in FIGS. 19 and 20, the aerodynamic door assembly 10 in one configuration comprises a frame 150 with at least one face panel (not shown) coupled to the frame 150. For example, the frame 150 may include a set of face panels on the outside of the frame 150 to form panels 12, 14, 16, 18, 20 and 22. In another configuration, the frame 150 includes two sets of face panels, one set mounted to the outside of the frame 150 and one set mounted to the inside of the frame 150. In yet another configuration, the face panels are within the frame 150, such that the frame 150 frames the perimeter edge of the face panels.

As shown in FIGS. 19-22, the aerodynamic door assembly 10 includes, in one configuration, a system 100 for deploying and retracting the panels 16, 18, 20, 22. The system 100 may be capable of deploying and retracting both sets of panels 16, 20 and 18, 22. Alternatively, the aerodynamic door assembly 10 includes two deployment/retraction systems 100: one for deploying and retracting the first set of panels 16, 20 and one for deploying and retracting the second set of panels 18, 22. In one configuration, the system is a movement system comprising upper and lower blocks 102, 104, a guide track 106 having two channels 108, 110, and a sled 112, 114 disposed within each channel 108, 110 of the guide track 106. Each sled 112, 114 is coupled to one end of a strut 116 and the corner of each panel 118, 120 is coupled to the other end of each strut 116. Thus, panel 118 is connected to a strut 116 while panel 120 is connected to a different strut 116 as shown in FIG. 19. When panels 118 and 120 are in the retracted position, struts 116 are proximate and substantially parallel to guide track 106 providing a compact design. For illustration purposes, FIG. 20 is shown with a strut 116 coupled to the upper panel 120, but without a strut coupled to lower panel 118. It should be appreciated that the struts 116 may be made of any impact resistant material such as metal, fiberglass, stainless steel, aluminum, rubber, plastic, high durometer plastic, etc. A flexible connecting member 122 such as a chain, rope, cable, or tape may be used to connect the sleds 112, 114 to the blocks 102, 104. In a configuration, the blocks 102, 104 are positioned on the upper portion 124 and lower portion 126 of each door 4, 6 and the guide track 106 is positioned therebetween. It should be appreciated by those having ordinary skill in the art that the blocks 102, 104 in the movement system may be any type of pulley block or gear. A crank 128 may be coupled to the deployment/retraction system 100. The crank 128 may be any type of automatic or hand driven device capable of actuating the deployment system, including but not limited to a handle, an electric crank motor, cam unit, axel, or similar device. While the crank 128 may be located anywhere on the aerodynamic door assembly 10, the crank 128 is preferably located at a height. The system 100 may include a lock to maintain the sets of panels 16, 20 and 18, 22 in either the deployed position or the retracted position, as selected by a user. In one configuration, the lock is within the crank 128. In another configuration, the lock is part of the guide track 106.

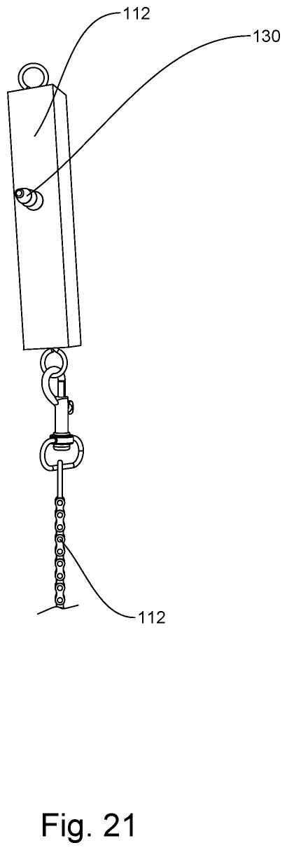

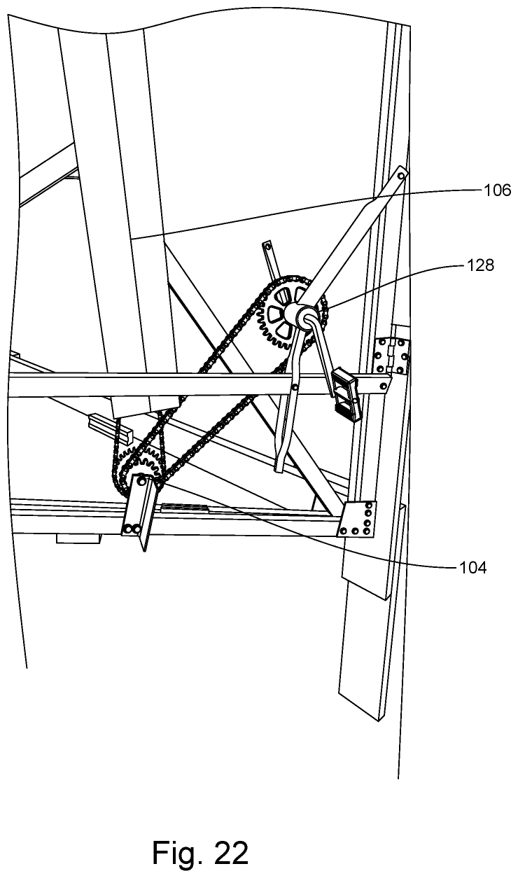

As shown in FIG. 22, in this embodiment, to deploy the system 10, a crank 128 is rotated, thereby causing the lower block or gear 104 to rotate. The rotation of the gear 104 translates one of the sleds 112 in a first direction and the other sled 114 in a second, opposite direction. For example, as shown in FIGS. 19-22, the top panel sled 114 moves upward in the channel 110 of the guide track 106 to raise the top panel 16 into the deployed position while the lower panel sled 112 moves downward in the channel 108 of the guide track 106 to move the bottom panel 20 downward in the deployed position. As shown in FIG. 21, the sled 112, 114 may include a pin 130 for connecting the strut 116 to one of the sleds 112, 114. To retract the top and bottom panels 16, 20, the crank or handle 128 is rotated in the opposite direction, thereby causing the lower block or gear 104 to rotate in the opposite direction. Thus, each sled 112, 114 will be translated in the channel 108, 110 of the guide track 106 in the direction opposite of its deployed position.

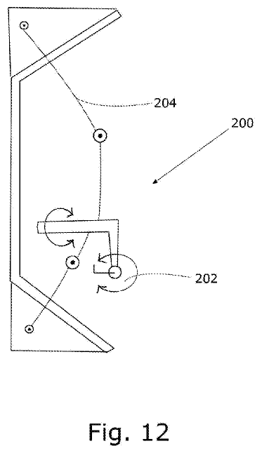

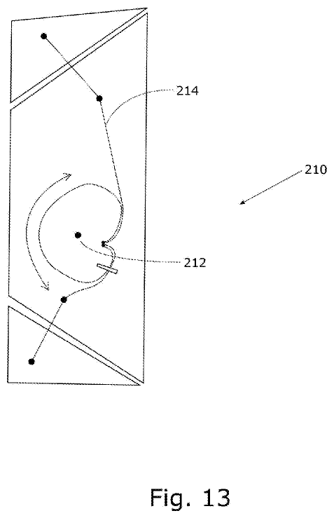

In another configuration, the system 100 for deploying and retracting the panels 16, 18, 20, 22 includes a crank handle and cable system 200 as shown in FIG. 12, wherein upon rotating the crank handle 202 in a first direction, tension on the cable 204 is released and one set of the panels 16, 18, or 20, 22 pivot in a deployed position. Upon rotating the crank handle 202 in a second direction, tension is placed on the cable 204 causing one set of the panels 16, 18 or 20, 22 to pivot into the retracted position. In an alternative configuration, system 210 for deploying and retracting the panels 16, 18, 20, and 22 includes a cam 212 and cable 214 as shown in FIG. 13. Additional movement systems may be used and these systems are intended to be included within the scope of the invention as claimed. For example, it should be appreciated that the system may be a manual, electric, hydraulic or other type of movement system. Further, the movement system may be disposed on either face side of the middle panel 12, 14, or bottom panels 20, 22 or internally between two sheets of material forming the panels 12, 14.

The top and bottom panels 16, 18, 20, 22 may be attached to the middle panels 12, 14 using a spring and hinge mechanism 250.

In a configuration of the invention, the perimeter edge of the rear of the vehicle may be encapsulated with a seal or weather guard to reduce the drag of the surface and to prevent leaking into the access port of the semitrailer. The seal or weather guard may be, for example, an elastomeric tape, tubing, or molded part. In a configuration, the rubber piece is approximately one to six inches wide, and more preferably, between one and four inches wide, and even more preferably two to four inches wide.

It should be appreciated by those having ordinary skill in the art that the aerodynamic door assembly 10 may be an external door that is constructed as part of the original equipment on a semitrailer. Alternatively, the aerodynamic door assembly 10 may be retrofit on an existing semitrailer. In one configuration, the semitrailer 8 includes an internal barrier for preventing the contents of the semitrailer 8 from shifting onto or adjacent the doors 4, 6 and to protect the semitrailer 8 and any cargo from environmental conditions. The internal barrier may be, for example, a gate, internal door or roll-up overhead door of the semitrailer, bar or bars, or straps, as well as other barriers.

As shown in FIGS. 1-9, the top and bottom panels 16, 18, 20, 22 are angled. Preferably, the angle between the edge 40, 42 and 54, 56 of the top and bottom panels 16, 18, 20, 22 and the semitrailer 8 is between 15 and 90 degrees. More preferably, the angle between the edge 40, 42 and 54, 56 of the top and bottom panels 16, 18, 20, 22 and the semitrailer 8 is between 30 and 60 degrees. It should be appreciated by those having ordinary skill in that art that the angles may vary depending on the semitrailer dimensions, the desired reduction in drag, and the manufacturing techniques employed. The greater the distance between the corner edge 70, 72, 74, 76 of the top and bottom panels 16, 18, 20, 22 and the rear of the semitrailer 8, the greater the reduction in drag.

The rear door assembly 10 may be made of wood, composite, fiberglass, metal, plastic or other type of material. Preferably, the material is lightweight and resistant to damage and denting. In a configuration of the invention, the material is an aluminum composite material, for example, DiBond® aluminum composite material, which is available at 3A Composites GmbH located at Alusingenplatz 1, 78224 Singen/Hohentwiel, Germany. In another configuration, the rear door assembly comprises a frame and at least one face panel overlaying the frame or held within the frame.

The panels may be locked using standard semitrailer door locks for cargo doors, rolling doors and the like. In one configuration, the lock is secured to each of the bottom panels 20, 22. The door lock may include a lock lever arm, that when actuated moves a pin into a pin box on the truck. An example of a lock that may be utilized is the Todco® Fleet Engineers Door Lock Latch available on the website http://www.ryderfleetproducts.com/home.

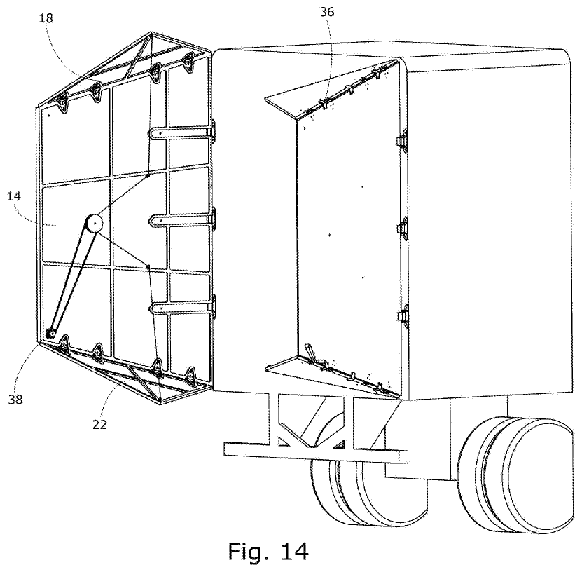

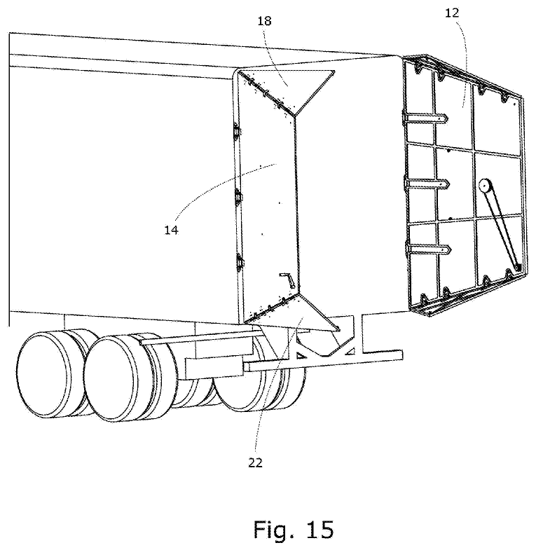

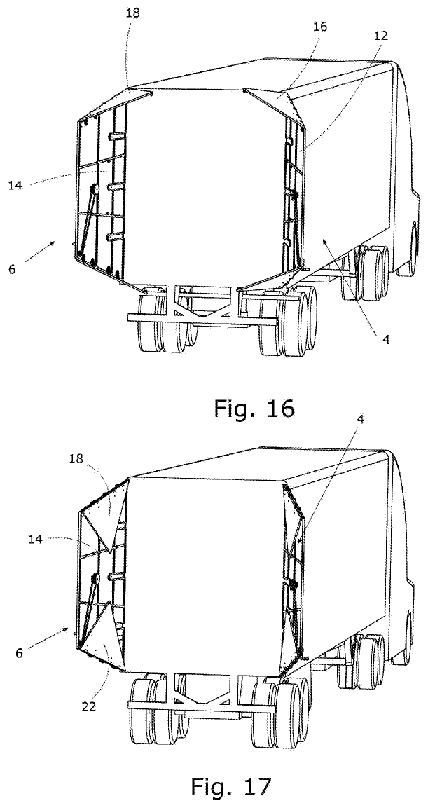

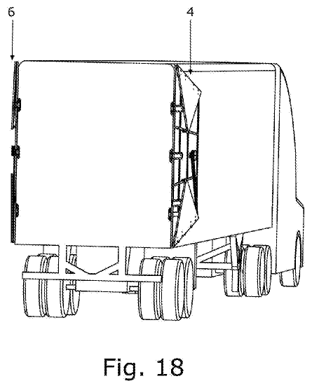

As shown in FIGS. 14-18, the aerodynamic door assembly 10 on a semitrailer 8 may be deployed, in one configuration, as follows. First, the top and bottom panels 16, 20 are pivoted along the side edge of the convergent middle panel 12 of a first set of articulated panels 4. The top and bottom panels 18, 22 of a second set of articulated panels 6 may be pivoted simultaneously or separately from the first set 4. Secondly, the top and bottom panels 16, 18, 20, 22 are secured into an open, deployed position. Next, the outer edge 28 of the convergent middle panel 12 of the first set of articulated panels 4 is aligned and disposed adjacent to an outer edge 30 of the convergent middle panel 14 of the second set of articulated panels 6. The first side edge 40, 52 of the top and bottom panels 16, 20 of the first set of articulated panels 4 is positioned adjacent an edge of the rear portion of the semitrailer 8 and the first side edge 42, 54 of the top and bottom panel 18, 22 of the second set of articulated panels 6 is positioned adjacent an edge of the rear portion of the semitrailer 8. Additionally, a second side edge 44, of the top panel 16 of the first set of articulated panels 4 is positioned adjacent a second side edge 46 of the top panel 18 of the second set of articulated panels 6. Further, a second side edge 56 of the bottom panel 20 of the first set of articulated panels 4 is positioned adjacent a second side edge 58 of the bottom panel 22 of the second set of articulated panels 6. Once the aerodynamic door assembly 10 is in the deployed position, the first and second sets of articulated panels 4, 6 are secured by engaging a lock.

To retract the aerodynamic door assembly, the lock or locks are disengaged. Then, the sets are articulated panels 4, 6 are pivoted on hinges 252. The upper and lower panels 16, 18 and 20, 22 are folded inwardly against the inside face of the middle panel 12, 14 by engaging the upper and lower panel movement system. The sets of articulated panels 4, 6 are then pivoted outwardly such that the outer face of the articulated panels 4, 6 are adjacent the outer face of the semitrailer body. This permits the semitrailer to be parked at a loading dock or proximate other semitrailers.

Although the present disclose describes particular configurations, it is not limited to these configurations. Alternative configurations, embodiments, or modifications, which will be encompassed by the invention can be made by those skilled in the configurations, embodiments, modifications or equivalents, may be included in the spirit and scope of the invention, as defined by the appended claims.

1. An aerodynamic door assembly for a semitrailer having a rear portion, the aerodynamic door assembly comprising:
a first set of articulated panels having a convergent middle panel and at least one of a top panel and a bottom panel, the first set moveable between an open, deployed configuration and a closed, retracted configuration; and
a second set of articulated panels having a convergent middle panel and at least one of a top panel and a bottom panel, the second set moveable between an open, deployed configuration and a retracted configuration, wherein in the deployed configuration an outer edge of the convergent middle panel of the first set of articulated panels is proximate an outer edge of the convergent middle panel of the second set of articulated panels and spaced from the rear portion of the semitrailer.

2. The aerodynamic door assembly of claim 1, wherein each convergent middle panel further comprises side edges, wherein the top and bottom panels each pivotally rotate along one of the side edges.

3. The aerodynamic door assembly of claim 1, wherein each set of articulated panels has a top panel and a bottom panel.

4. The aerodynamic door assembly of claim 3, wherein each top panel and bottom panel has three sides and is substantially triangular.

5. The aerodynamic door assembly of claim 4, wherein each convergent middle panel further comprises side edges, wherein one of the triangular sides of the top and bottom panel each pivotally rotate along a side edge of the convergent middle panel.

6. The aerodynamic door assembly of claim 5, wherein in the deployed configuration, one of the triangular sides of the top panel of the first set of articulated panels is proximate one of the triangular sides of the top panel of the second set of articulated panels, and wherein one of the triangular sides of each of the top panels is proximate the top rear portion of the semitrailer.

7. The aerodynamic door assembly of claim 5, wherein in the deployed configuration, one of the triangular sides of the bottom panel of the first set of articulated panels is proximate one of the triangular sides of the bottom panel of the second set of articulated panels, and wherein one of the triangular sides of each of the bottom panels is proximate the bottom rear portion of the semitrailer.

8. The aerodynamic door assembly of claim 3, wherein in the retracted configuration the top and bottom panels pivot inwardly toward an inner face of the convergent middle panel.

9. The aerodynamic door assembly of claim 3, wherein in the retracted configuration, the first and second set of articulated panels are adjacent the rear side portion of the semitrailer.

10. The aerodynamic door assembly of claim 1 further comprising a controller for selectively deploying and retracting top and bottom panels.

11. The aerodynamic door assembly of claim 10, wherein the controller further comprises a cam unit and tension cables connected to the top and bottom panels, and wherein the top and bottom panels pivotally rotate inwardly towards an inner face of the convergent middle panel when the cam unit is rotated in a first direction.

12. The aerodynamic door assembly of claim 10, further including a handle positioned on an outer face of the convergent middle panel and coupled to the controller, the handle moveable in a first direction to selectively deploy top and bottom panels.

13. The aerodynamic door assembly of claim 1, wherein the first set of articulated panels is coupled to the second set of articulated panels in the deployed configuration.

14. The aerodynamic door assembly of claim 13, wherein the first set of articulated panels interlocks with the second set of articulated panels in the deployed configuration.

15. The aerodynamic door assembly of claim 1, further comprising an inner barrier.

16. The aerodynamic door assembly of claim 1, wherein the door assembly defines an exterior and encloses an interior space of the semitrailer.

17. A method of deploying an aerodynamic door assembly on a semitrailer having a rear portion comprising:
(a) pivoting at least one of a top and bottom panel along a side edge of a convergent middle panel of a first set of articulated panels;
(b) securing the at least one of the top and bottom panel of the first set of articulated panels in an open position;
(c) pivoting at least one of a top and bottom panel along a side edge of a convergent middle panel of a second set of articulated panels;
(d) securing the at least one of the top and bottom panel of the second set of articulate panels in an open position;
(e) aligning an outer edge of the convergent middle panel of the first set of articulated panels adjacent with an outer edge of the convergent middle panel of the second set of articulated panels.

18. The method of deploying an aerodynamic door assembly on a semitrailer of claim 15 further comprising:
(f) positioning a first side edge of the at least one of the top and bottom panels of the first set of articulated panels adjacent an edge of the rear portion of the semitrailer; and
(g) positioning a first side edge of the least one of the top and bottom panel of the second set of articulated panels adjacent an edge of the rear portion of the semitrailer.

19. The method of deploying an aerodynamic door assembly on a semitrailer of claim 16 further comprising:
(h) positioning a second side edge of the top panel of the first set of articulated panels adjacent a second side edge of the top panel of the second set of articulated panels; and
(i) positioning a second side edge of the bottom panel of the first set of articulated panels adjacent a second side edge of the bottom panel of the second set of articulated panels.

20. The method of deploying an aerodynamic door assembly on a semitrailer of claim 17 further comprising:
(j) locking the first and second sets of articulated panels into a deployed configuration.
